(19) United States
(12) Patent Application Publication
(10) Pub. No.: US 2016/0350273 A1
(43) Pub. Date: Dec. 1, 2016

(54) DATA PROCESSING METHOD

(71) Applicants: Chieh-Yu Chan, Taipei City (TW); Ming-Che Weng, Taipei City (TW); Ji-Hong Huang, Taipei City (TW); Chia-Ni Chen, Taipei City (TW)

(72) Inventors: Chieh-Yu Chan, Taipei City (TW); Ming-Che Weng, Taipei City (TW); Ji-Hong Huang, Taipei City (TW); Chia-Ni Chen, Taipei City (TW)

(73) Assignee: COMPAL ELECTRONICS, INC., Taipei City (TW)

(21) Appl. No.: 14/994,143

(22) Filed: Jan. 13, 2016

(30) Foreign Application Priority Data
Jun. 1, 2015 (TW) 104117652

(51) Int. Cl. G06F 17/24; G06F 3/0354; G06F 3/0483; G06F 3/0486; G06F 3/0484; G06F 3/0488; G06K 9/22; G06F 3/0482

(52) U.S. Cl. CPC G06F 17/242; G06K 9/222; G06F 3/03545; G06F 3/0482; G06F 3/0486; G06F 3/04842; G06F 3/04883; G06F 3/0483

(57) ABSTRACT

A data processing method for processing handwritten input data displayed on a display unit is provided. The data processing method includes: performing a select operation to the handwritten input data according to a trace of a touch operation being received; after detecting that the touch operation is released, displaying a menu and setting a manageable object according to an area selected by the select operation, wherein the menu includes a plurality of function options, and the manageable object provides a drag function; and adding the manageable object into a corresponding page of an enabled one of the function options.

### CROSS-REFERENCE TO RELATED APPLICATION

This application claims the priority benefit of Taiwan application Ser. No. 104117652, filed on Jun. 1, 2015. The entirety of the above-mentioned patent application is hereby incorporated by reference herein and made a part of this specification.

### BACKGROUND OF THE INVENTION

1. Field of the Invention

The disclosure relates to a data processing method, and more particularly, to a data processing method for processing data displayed by an electronic device.

2. Description of Related Art

With advancements in technologies, traditional paper data has been gradually replaced by electronic data. The electronic data is easy to store and convenient to carry around with, and can be easily searched as compared to the traditional paper data. Accordingly, the electronic device gradually becomes a popular tool for recording data in the field of word processing, and provides users functions such as recording memo or drawing. For instance, use of traditional notebook is no longer required for taking notes in the classroom or the conference room. Instead, with use of the handwritten input in the electronic device (e.g., a laptop computer, a tablet computer or a smart phone) having an electronic notebook function, users can still have the same experience of taking notes with paper and pen.

However, among the traditional applications for the electronic notebook that utilizes the handwritten input, one specific type of the applications is capable of converting text of handwritten input into digital text to be recorded into the electronic notebook, but this type of the applications does not allow the users to perform selecting or marking operations freely. Another type of the applications is capable of converting text, lines, and labels of the handwritten input into images to be recorded. Nonetheless, in the application that converts the handwritten content into the images, it is difficult for the user to perform further managements on the text content of the handwritten input.

### SUMMARY OF THE INVENTION

The disclosure is directed to a data processing method capable of providing the users with an experience of instant writing of the actual paper notebook and performing further management and edit to the noted content quickly and effectively.

A data processing method for processing handwritten input data displayed on a display unit is provided according to an embodiment of the disclosure. The data processing method includes: performing a select operation to the handwritten input data according to a trace of a touch operation being received; after detecting that the touch operation is released, displaying a menu and setting a manageable object according to an area selected by the select operation, wherein the menu includes a plurality of function options, and the manageable object provides a drag function; and adding the manageable object into a corresponding page of an enabled one of the function options.

In an embodiment of the disclosure, after the step of setting the manageable object, the data processing method further includes: dragging the manageable object to a position between any two other manageable objects according to a drag operation performed to the manageable object.

In an embodiment of the disclosure, after detecting that the touch operation is released, a menu is displayed and one of the function options is selected according a selection of a user. Further, after selecting the one of the function options, the select operation is set according to the area selected by the select operation.

In an embodiment of the disclosure, after detecting that the touch operation is released, a manageable object is set according to an area selected by the select operation.

Further, after setting the manageable object, a menu is displayed, and one of the function options is selected according to a selection of a user.

In an embodiment of the disclosure, the step of setting the manageable object includes: after detecting that the touch operation is released, performing an image-capturing action to the area selected by the select operation in order to set a screenshot as the manageable object.

In an embodiment of the disclosure, after detecting that the touch operation is released, the data processing method further includes: performing a text recognition to the area selected by the select operation to obtain digital text data; and associating the manageable object with the digital text data.

In an embodiment of the disclosure, the data processing method further includes: after one of the function options having a connection relationship with a calendar application is enabled, adding the digital text data corresponding to the manageable object into a things to-do page of the calendar application according to date information included in the digital text data.

In an embodiment of the disclosure, the data processing method further includes: while performing the select operation, displaying a trace of the select operation by a predetermined line type according to the trace of the touch operation being received.

In an embodiment of the disclosure, the function options are configured to classify the manageable object to different folders.

In an embodiment of the disclosure, after the step of adding the manageable object into the corresponding page of the enabled function option, the data processing method further includes: performing a marking action to the manageable object.

In an embodiment of the disclosure, the data processing method further includes: after one of the function options is enabled, displaying a plurality of sub options corresponding to the enabled function option; and adding the manageable object into a corresponding page of an enabled one of the sub options.

Based on the above, other than keeping the experience of instant writing in the actual paper notebook, the data processing method of the disclosure is also capable of setting the selected data as the manageable object and providing the corresponding menu for the user to quickly perform further management to the selected data, so as to improve the efficiency of taking notes.

To make the above features and advantages of the present disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram illustrating an electronic device according to an embodiment of the disclosure.

FIG. 2 is a flowchart illustrating a data processing method according an embodiment of the disclosure.

FIG. 3A to FIG. 3C are schematic diagrams illustrating the data processing according to an embodiment of the disclosure.

FIG. 4 is a schematic diagram illustrating a memo page according to an embodiment of the disclosure.

FIG. 5 is a schematic diagram illustrating a things to-do page according to an embodiment of the disclosure.

FIG. 6A to FIG. 6D are schematic diagrams illustrating a label function option according to an embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

The traditional electronic notebook/note taking applications are unable to directly manage or edit a handwritten note content. Accordingly, the disclosure provides a data processing method, which is capable of performing managing and editing operations to a specific note content selected at any time while keeping actual experience of taking notes. In order to make description of the disclosure more comprehensible, embodiments are described below as the examples to prove that the disclosure can actually be realized.

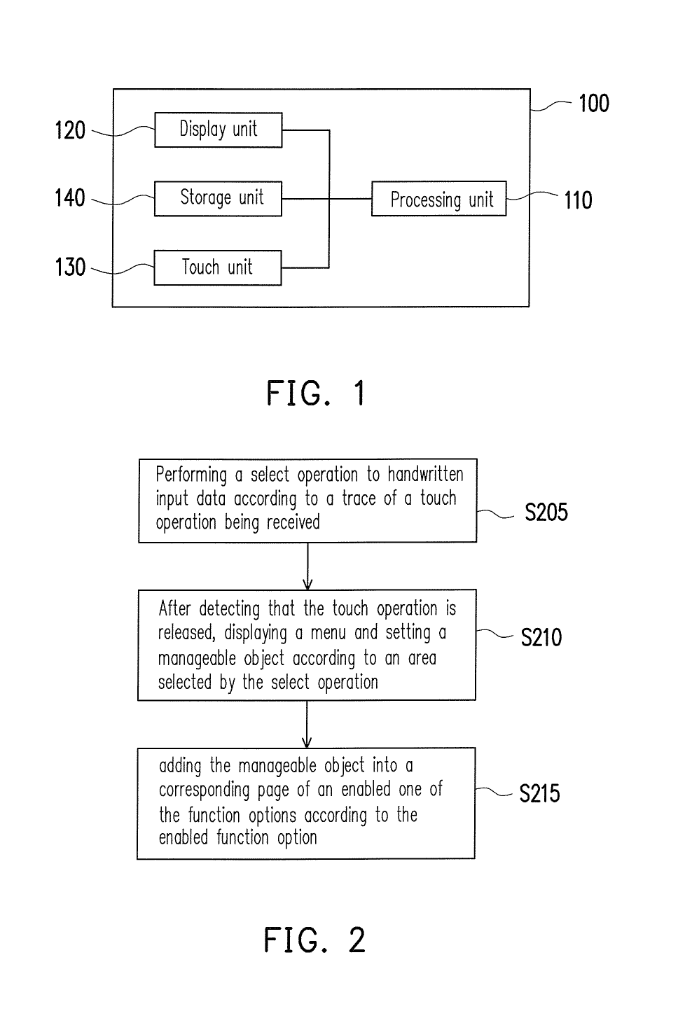

FIG. 1 is a block diagram illustrating an electronic device according to an embodiment of the disclosure. Referring to FIG. 1, an electronic device 100 is, for example, consumer electronics such as a cell phone, a tablet computer, a laptop computer or a desktop computer. The electronic device 100 at least includes a processing unit 110, a display unit 120, a touch unit 130 and a storage unit 140.

The processing unit 110 is coupled to the display unit 120, the touch unit 130 and the storage unit 140. The processing unit 110 is a hardware having a computing capability (e.g., a chip set, a processor, etc.), and configured to control overall operations of the electronic device 100. In the present embodiment, the processing unit 110 is, for example, a central processing unit (CPU), a micro-processor, other programmable microprocessors, a digital signal processor (DSP), a programmable controller, an application specific integrated circuits (ASIC), a programmable logic device (PLD) or other similar devices.

The display unit 120 is, for example, a cathode ray tube (CRT) display, a liquid crystal display (LCD), a plasma display, a light-emitting diode (LED) display, a field emission display (FED) and the like.

The touch unit 130 may include a touch panel, a touch button and/or a touch roller, and may be implemented by various touch sensing technologies such as a resistive type, a capacitive type, an optical type, an acoustic wave type, an electromagnetic type and the like, but a type of the touch unit 130 is not limited to the above. For example, a user may tap or slide on the touch unit 130 by using fingers, a stylus or various touch input devices such that the touch unit 130 generates an input signal. Further, the display unit 120 and the touch unit 130 may also be integrated as a touch screen.

The storage unit 140 is, for example, a fixed or a movable device in any possible forms including a random access memory (RAM), a read-only memory (ROM), a flash memory, a hard drive or other similar devices, or a combination of the above-mentioned devices. The storage unit 140 is capable of storing data based on instructions from the processing unit 110, and the data includes data for managing the electronic device 100, data inputted by the user or data of other types, which are not particularly limited in the disclosure. In the present embodiment, a computer program product is stored in the storage unit 140. The computer program product is basically assembled by a plurality of program sections, and the computer program product may be executed by the processing unit 110 to perform the data processing method below. In another embodiment, the storage unit 140 may also be included in the processing unit 110.

In the present embodiment, when the user starts an electronic notebook/note taking application in the electronic device 100 for taking electronic notes, the processing unit 110 starts to execute the following flows based on operation instructions from the user. FIG. 2 is a flowchart illustrating a data processing method according an embodiment of the disclosure. Referring to FIG. 1 and FIG. 2, in step S205, the processing unit 110 performs a select operation to handwritten input data according to a trace of a touch operation being received. For example, the user may use input tools such as fingers or a stylus to perform the touch operation in order to complete the select operation. Any square or rectangular part or any irregularly shaped part of the handwritten input data is selected by the select operation. The processing unit 110 detects the trace of the touch operation currently performed by the user, so as to perform the select operation to the handwritten input data based on said trace. For example, a selected line segment (i.e., the trace of the select operation) is correspondingly displayed by a predetermined line type in the display unit 120 with the trace of the detected touch operation.

Subsequently, in step 5210, after detecting that the touch operation is released, the processing unit 110 displays a menu and sets a manageable object according to an area selected by the select operation. Herein, the menu includes a plurality of function options. The manageable object further provides a drag function. That is, the user may perform a drag operation to drag the manageable object, so as to adjust a position order of the manageable object.

The processing unit 110 determines whether the select operation is completed according to whether the touch operation is released. For the touch operation performed by using the stylus, after the stylus leaves the touch unit 130, the processing unit 110 may determine that the select operation is completed to thereby set the manageable object and display the menu, so that the user may select one of the function options in the menu in order to perform the corresponding data processing to the manageable object. The manageable object is, for example, a screenshot. After detecting that the touch operation is released, the processing unit 110 performs an image-capturing action to the area selected by the select operation in order to set the screenshot as the manageable object. For example, the processing unit 110 determines a dimension (i.e., a length and a width) of the screenshot according to longest distances in a horizontal direction and a vertical direction of the area selected by the select operation. Further, the processing unit 110 sets the screenshot as the manageable object.

By using the above-mentioned steps, the processing unit 110 is capable of setting multiple manageable objects in the handwritten input data. Each of the manageable objects has the drag function provided for the user to perform the drag operation. According to the drag operation performed to one of the manageable objects by the user, the processing unit 110 drags the manageable object to a position between any two other manageable objects.

After detecting that the touch operation is released, the processing unit 110 may display the menu first for the user to make a selection on the function options, such that the processing unit 110 may select one of the function options according to the selection of the user. After selecting the one of the function options, the processing unit 110 then sets the manageable object according to the area selected by the select operation.

In addition, after detecting that the touch operation is released, the processing unit 110 may also set the manageable object first according to the area selected by the select operation. Only after the manageable object is set, the processing unit 110 then displays the menu for the user to make the selection on the function options so that the processing unit 110 may select one of the function options according to the selection of the user. In other words, the action of creating the manageable object may be performed right after the touch operation is released, and may also be performed only after the touch operation is released and the one of the function options is selected, namely, a priority for displaying the menu and setting the manageable object may be decided for different situations.

The processing unit 110 may further perform a text recognition to the area selected by the select operation to obtain digital text data, and associate the select operation with the digital text data. In other words, what being viewed by the user is still a handwritten image in a display frame, but the processing unit 110 may further perform other data processing to the digital text data corresponding to the manageable object based on the enabled function option.

After the function option is enabled, in step S215, the processing unit 110 adds the manageable object into a corresponding page of the enabled function option according to the enabled function option. The function options are, for example, configured to classify the manageable object to different folders. Further, the processing unit 110 changes an appearance of the enabled function option. For example, a button of the enabled function option may be enlarged or highlighted.

For clearer description, another embodiment is given for illustration below. In the following embodiments, description is provided by using an example in which the manageable object is set only after the touch operation is released and the one of the function options is enabled.

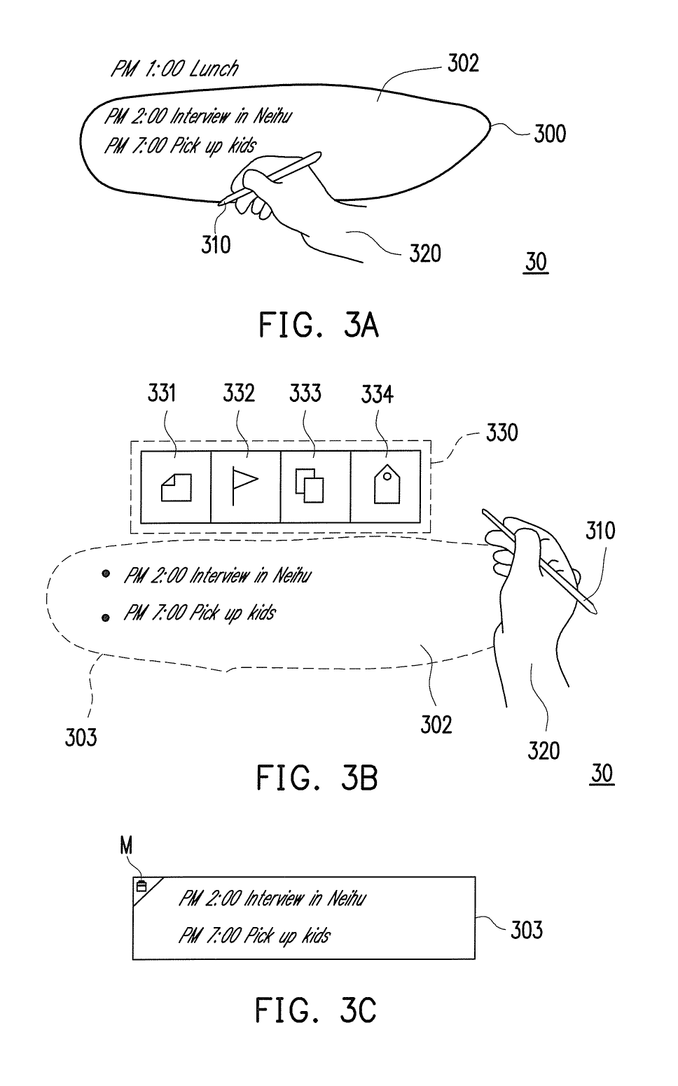

FIG. 3A to FIG. 3C are schematic diagrams illustrating the data processing according to an embodiment of the disclosure. In the present embodiment, the display unit 120 and the touch unit 130 are integrated into a touch screen, and an electronic notebook operating interface 30 is displayed on the touch screen.

As shown by FIG. 3A, a user 320 uses a stylus 310 to perform the touch operation on the touch screen, and uses the stylus 310 to perform handwritten input and data processing in the electronic notebook operating interface 30. Herein, the handwritten input data inputted by the user 320 includes “PM 1:00 Lunch”, “PM 2:00 Interview in Neihu” and “PM 7:00 Pick up kids”. In FIG. 3A, the processing unit 110 performs the select operation to an area 302 selected by a trace 300 according to the trace 300 of the touch operation being received. When detecting that the stylus 310 leaves the touch screen, the processing unit 110 determines that the select operation is completed.

Further, after the processing unit 110 detects that the stylus 310 leaves the touch screen, the processing unit 110 may further determine whether the select operation is completed according to the trace 300. For instance, the processing unit 110 determines whether the area 302 surrounded by the trace 300 at least includes a part of the handwritten input data and whether the trace 300 is a closed graphic. If the area 302 surrounded by the trace 300 at least includes the part of the handwritten input data and the trace 300 is the closed graphic, it is determined that the touch operation currently performed is a select operation. In addition, it is also possible that the trace 300 is not a closed graphic, as long as a start point and an end point thereof are located within an acceptable range and the trace 300 is substantially a closed graphic. Nevertheless, said embodiment is merely an example, and the disclosure is not limited thereto.

After the touch operation is released, the processing unit 110 displays a menu 330 near the area 302 according to the area 302 selected by the select operation, as shown by FIG. 3B. The menu 330 includes a plurality of function options 331 to 334. After one of the function options is enabled, the processing unit 110 determines a dimension of a screenshot according to longest distances in a horizontal direction and a vertical direction of the selected area 302, and sets the screenshot as a manageable object 303, as shown by FIG. 3C. Further, after adding the manageable object 303 into a corresponding page of the enabled function option, the processing unit 110 may selectively perform a marking action to the manageable object 303. As shown by FIG. 3C, an icon M is added into the manageable object 303, so as to indicate that the manageable object 303 has been added into the corresponding page of the enabled function option.

In the present embodiment, the function option 331 is a memo function configured to classify the manageable object 303 into a backup folder. The function option 332 is a to-do function configured to add the manageable object 303 into a things to-do page of a calendar application. The function option 333 is a copy function configured to perform a copy operation to the manageable object 303. The function option 334 is a label function configured to classify the manageable object 303 to be under one of the labels. However, the function options 331 to 334 are merely examples, and the disclosure is not limited thereto. In other embodiments, amount and functions of the function options provided by the menu 330 may be determined based on different requirements.

Actions taken when each of the function options 331 to 334 is enabled are described as follows.

After the function option 331 is enabled, the processing unit 110 sets the manageable object according to the selected area 302, and performs the text recolonization to the handwritten input data within the area 302 to obtain the digital text data. Further, the processing unit 110 associates the manageable object 330 with the corresponding digital text data. Thereafter, the processing unit 110 adds the manageable object 303 and the corresponding digital text data into a memo page for the user to directly browse them in the memo page.

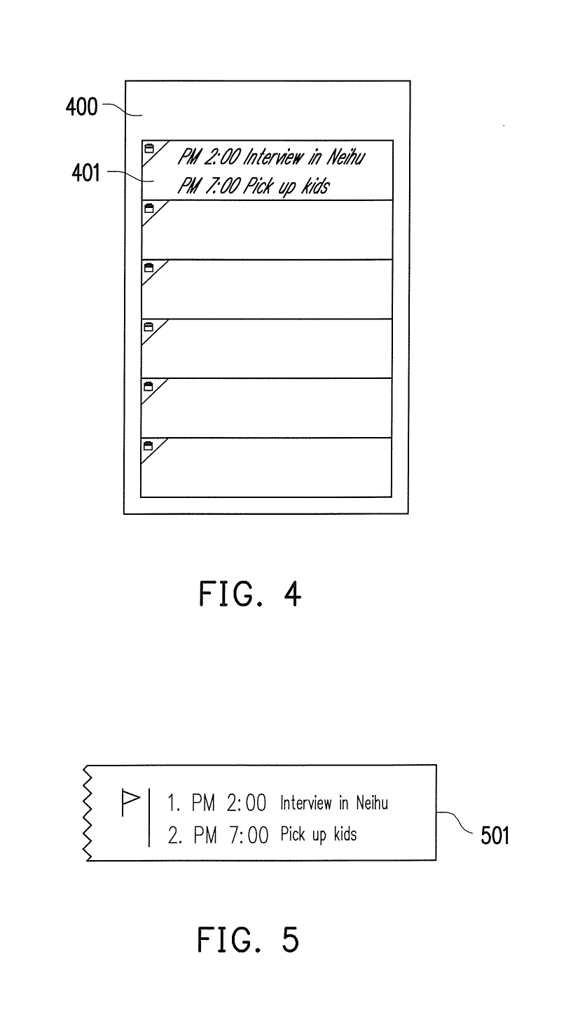

For example, FIG. 4 is a schematic diagram illustrating a memo page according to an embodiment of the disclosure. Referring to FIG. 4, the processing unit 110 copies the manageable object 303 in order to obtain a memo object 401 and adds the memo object 401 into the memo page 400. Herein, the processing unit 110 may further change a size of the memo object 401 according to settings of the memo page 400. In the present embodiment, the newly added memo object 401 is displayed on the top of the memo page 400, but the disclosure is not limited thereto. For example, in another embodiment, the newly added memo object 401 may also be added to the bottom of the memo page 400.

Further, during the process of performing the electronic notebook application, an operation for switching between the memo page 400 and the electronic notebook operating interface 30 may be set as follows. After the processing unit 110 detects the touch operation that slides from a left edge of the screen to the right, the processing unit 110 opens the memo page 400 so that the user 320 may check the memo page 400. Furthermore, during browsing the memo page 400, after the processing unit 110 detects the touch operation that slides from a right edge of the screen to the left, the processing unit 110 re-display the electronic notebook operating interface 30. The touch operation for opening the memo page 400 and the touch operation for re-displaying the electronic notebook operating interface 30 are merely examples, and the disclosure is not limited thereto.

Referring back to FIG. 3B, when the function option 332 is enabled, the processing unit 110 adds the digital text data corresponding to the manageable object into the things to-do page of the calendar application according to date information included in the digital text data.

For example, FIG. 5 is a schematic diagram illustrating a things to-do page according to an embodiment of the disclosure. Referring to FIG. 3B, FIG. 3C and FIG. 5, after the function option 332 is enabled, the processing unit 110 sets the manageable object 303 (as shown by FIG. 3C) according to the selected area 302, and performs the text recolonization to the handwritten input data within the area 302 to obtain the digital text data. Thereafter, the processing unit 110 generates a to-do object 501 according to the digital text data corresponding to the manageable object 303, and adds the to-do object 501 into a things to-do page.

In addition, if there is a connection relationship between the function option 332 and the calendar application, the processing unit 110 further adds the digital text data corresponding to the manageable object 303 into the things to-do page of the calendar application.

Referring back to FIG. 3B, when the function option 333 is enabled, as described above, the processing unit 110 sets the manageable object 303 (as shown by FIG. 3C), and copies the manageable object 303. Later, the user may start other applications or opening other pages of the electronic notebook application based on demands in order to paste the copied manageable object 303 thereto.

In addition, when the function option 334 is enabled, the processing unit 110 may further display a plurality of sub options corresponding to the function option 334 for the user to select. Thereafter, the processing unit 110 may add the manageable object 303 into a corresponding page of an enabled sub option according to the enabled sub option.

Hereinafter, the label function option (the function option 334) is described as follows.

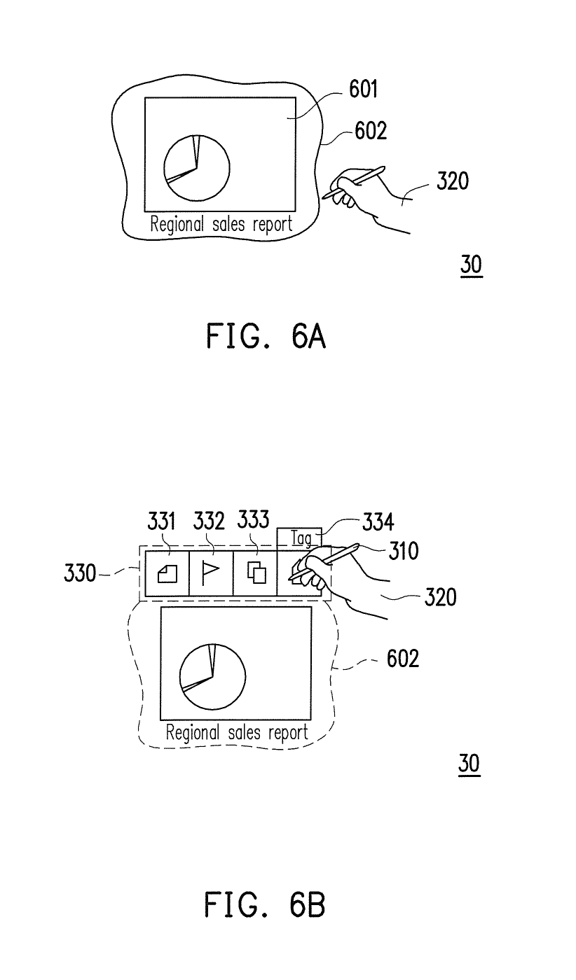

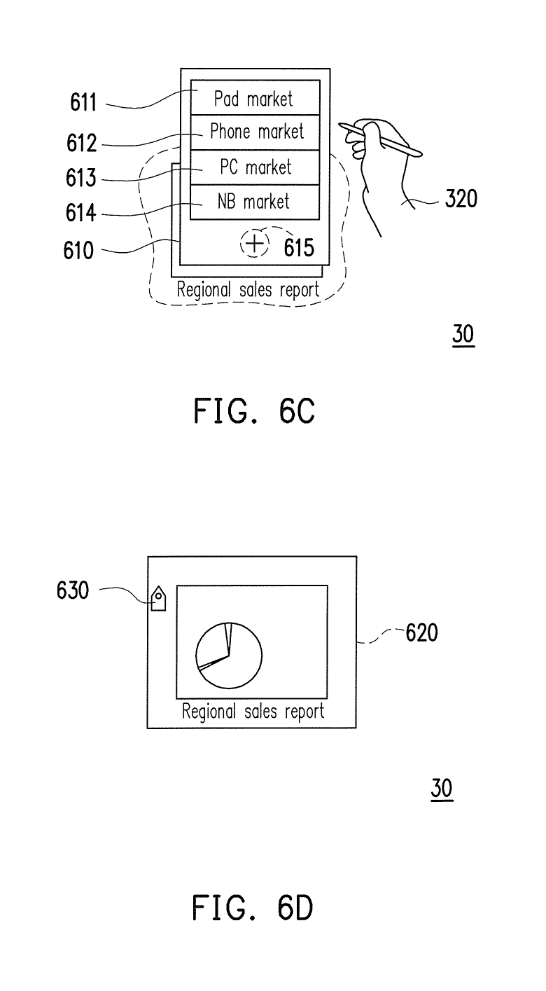

FIG. 6A to FIG. 6D are schematic diagrams illustrating the data processing in a label function option according to an embodiment of the disclosure. Referring to FIG. 6A, the electronic notebook operating interface 30 includes an image file 601. When the user intends to select the image file 601 in order to perform the processing to the image file 601, the processing unit 110 performs a select operation according to a trace 602 of the touch operation being received.

After detecting that the touch operation is released, as shown by FIG. 6B, the processing unit 110 displays the menu 330. Subsequently, the user 320 uses the stylus 310 to select the function option 334. After the function option 334 is enabled, the processing unit 110 further displays a sub menu 610, as shown by FIG. 6C. The sub menu 610 includes a plurality of sub options 611 to 614 and an adding option 615. The adding option 615 allows the user to create a new sub option.

Herein, it is assumed that the user has selected the sub option 612. After detecting that the sub option 612 is enabled, the processing unit 110 sets a manageable object 620 according to an area selected by the trace 602, as shown by FIG. 6D.

Thereafter, the processing unit 110 may add the manageable object 620 into a corresponding label page of the sub option 612.

By using the method described with reference to FIG. 6A to FIG. 6D, the user 320 is able to classify the manageable object 620 to different label pages, so as to enhance the management efficiency. In the present embodiment, the manageable object 620 may be classified into multiple label pages by selecting multiple sub options among the sub options 611 to 614.

After the manageable object 620 is classified, the processing unit 110 adds an icon 630 into the manageable object 620 in the electronic notebook operating interface 30 and/or the manageable object 620 in the label page. In addition, while the electronic notebook operating interface 30 is displayed, the user 320 may switch to the label page where the manageable object 620 is classified to by tapping on the icon 630. Herein, if the manageable object 620 is classified to multiple label pages, when the icon 630 of the manageable object 620 is tapped, the processing unit 110 displays a list including the label pages where the manageable object 620 is classified to, so that the user may select one of the label pages to be checked.

In addition, in the case where the displayed electronic notebook operating interface 30 includes multiple manageable objects, the user 320 may also directly tap on any position of one of the other manageable objects to call for the menu 330 so that the user may perform the subsequent operations. At the time, the menu 330 is displayed near the manageable object being tapped.

In summary, other than keeping the experience of instant writing in the actual paper notebook, the data processing method of the disclosure is also capable of setting the selected data as the object and providing the corresponding menu for the user to quickly perform further management to the selected data, so as to improve the efficiency of taking notes.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data processing method for processing handwritten input data displayed on a display unit of an electronic device, and the data processing method comprising:
performing a select operation to the handwritten input data according to a trace of a touch operation being received;
after detecting that the touch operation is released, displaying a menu and setting a manageable object according to an area selected by the select operation, wherein the menu includes a plurality of function options, and the manageable object provides a drag function; and
adding the manageable object into a corresponding page of an enabled one of the function options.

2. The data processing method of claim 1, wherein after the step of setting the manageable object, the data processing method further comprises:
dragging the manageable object to a position between any two other manageable objects according to a drag operation performed to the manageable object.

3. The data processing method of claim 1, wherein after detecting that the touch operation is released, the data processing method comprises:
displaying the menu;
selecting one of the function options according to a selection of a user; and
after selecting the function option, setting the select operation according to the area selected by the select operation.

4. The data processing method of claim 1, wherein after detecting that the touch operation is released, the data processing method comprises:
setting the select operation according to the area selected by the select operation;
after setting the manageable object, displaying the menu; and
selecting one of the function options according to a selection of a user.

5. The data processing method of claim 1, wherein the step of setting the manageable object further comprises:
performing an image-capturing action to the area selected by the select operation in order to set a screenshot as the manageable object.

6. The data processing method of claim 1, wherein after detecting that the touch operation is released, the data processing method further comprises:
performing a text recognition to the area selected by the select operation to obtain digital text data; and
associating the manageable object with the digital text data.

7. The data processing method of claim 6, further comprising:
after one of the function options having a connection relationship with a calendar application is enabled, adding the digital text data corresponding to the manageable object into a things to-do page of the calendar application according to date information included in the digital text data.

8. The data processing method of claim 1, further comprising:
while performing the select operation, displaying the trace of the select operation by a predetermined line type according to the trace of the touch operation being received.

9. The data processing method of claim 1, wherein the function options are configured to classify the manageable object to different folders respectively.

10. The data processing method of claim 1, wherein after the step of adding the manageable object into the corresponding page of the enabled function option, the data processing method further comprises:
performing a marking action to the manageable object.

11. The data processing method of claim 1, further comprising:
after one of the function options is enabled, displaying a plurality of sub options corresponding to the enabled function option; and
adding the manageable object into a corresponding page of an enabled one of the sub options.
